(19) United States
(12) Patent Application Publication
(10) Pub. No.: US 2025/0192390 A1
(43) Pub. Date: Jun. 12, 2025

(54) BATTERY CELL TAB CONFIGURATIONS

(71) Applicant: Ford Global Technologies, LLC, Dearborn, MI (US)

(72) Inventors: Minghong Liu, Northville, MI (US); Jiyun Park, Superior Township, MI (US); Kent Snyder, Dearborn, MI (US)

(21) Appl. No.: 18/531,861

(22) Filed: Dec. 7, 2023

(51) Int. Cl. H01M 50/548; B60L 50/64; H01M 10/6553; H01M 50/105; H01M 50/557

(52) U.S. Cl. CPC H01M 50/548; H01M 10/6553; H01M 50/105; H01M 50/557; B60L 50/64

(57) ABSTRACT

A battery cell may include a housing including a first edge, a second edge on an opposite side of the housing as the first edge, a third edge extending between the first and second edges, and a fourth edge on an opposite side of the housing as the third edge and extending between the first and second edges. A dimension of the first edge and a dimension of the second edge are greater dimensions than any other edges of the housing. A battery cell may include a first tab that protrudes outwardly from the first edge. A battery cell may include a second tab that protrudes outwardly from the second edge.

### TECHNICAL FIELD

This disclosure relates generally to electrified vehicle traction battery packs, and more particularly to battery cell tab configurations.

### BACKGROUND

A high voltage traction battery pack typically powers the electric machines and other electrical loads of an electrified vehicle. The traction battery pack includes a plurality of battery cells.

### SUMMARY

In some aspects, the techniques described herein relate to a battery cell, including: a housing including a first edge, a second edge on an opposite side of the housing as the first edge, a third edge extending between the first and second edges, and a fourth edge on an opposite side of the housing as the third edge and extending between the first and second edges, wherein a dimension of the first edge and a dimension of the second edge are greater dimensions than any other edges of the housing; a first tab that protrudes outwardly from the first edge; and a second tab that protrudes outwardly from the second edge.

In some aspects, the techniques described herein relate to a battery cell, wherein: the housing includes a centerline extending perpendicular to the first and second edges, a centerline of the first tab is spaced-apart from the centerline of the housing in the direction of the third edge, and a centerline of the second tab is spaced-apart from the centerline of the housing in the direction of the fourth edge.

In some aspects, the techniques described herein relate to a battery cell, wherein the centerline of the first tab is spaced-apart from the centerline of the housing by a different distance than the centerline of the second tab.

In some aspects, the techniques described herein relate to a battery cell, wherein: the first tab exhibits a greater surface area than the second tab, and the centerline of the first tab is spaced-apart from the centerline of the housing by a lesser distance than the centerline of the second tab.

In some aspects, the techniques described herein relate to a battery cell, wherein the first tab is spaced-apart from the third edge by a greater distance than the second tab is spaced-apart from the fourth edge.

In some aspects, the techniques described herein relate to a battery cell, wherein the first tab is spaced-apart from the third edge by a distance substantially 50% greater than the distance the second tab is spaced-apart from the fourth edge.

In some aspects, the techniques described herein relate to a battery cell, wherein the centerline of the second tab is spaced-apart from the centerline of the housing by a distance substantially 50% greater than the distance by which the centerline of the first tab is spaced-apart from the centerline of the housing.

In some aspects, the techniques described herein relate to a battery cell, wherein the surface area of the first tab is substantially twice the surface area of the second tab.

In some aspects, the techniques described herein relate to a battery cell, wherein a dimension of an end of the first tab is substantially twice a dimension of an end of the second tab.

In some aspects, the techniques described herein relate to a battery cell, wherein the first tab and the second tab protrude outwardly beyond respective first and second edges, respectively, by the same distance.

In some aspects, the techniques described herein relate to a battery cell in claim 1, wherein the housing is a flexible pouch.

In some aspects, the techniques described herein relate to a battery cell, wherein the battery cell is part of a battery pack of an electrified vehicle.

In some aspects, the techniques described herein relate to a battery cell, including: a housing including a first edge, a second edge on an opposite side of the housing as the first edge, a third edge extending between the first and second edges, and a fourth edge on an opposite side of the housing as the third edge and extending between the first and second edges, wherein a dimension of the first edge and a dimension of the second edge are greater dimensions than any other edges of the housing; a first tab that protrudes outwardly from the first edge; a second tab that protrudes outwardly from the second edge; wherein the first tab exhibits a greater surface area than the second tab, and wherein the first tab is closer to the third edge than the fourth edge and the second tab is closer to the fourth edge than the third edge.

In some aspects, the techniques described herein relate to a battery cell, wherein the surface area of the first tab is substantially twice the surface area of the second tab.

In some aspects, the techniques described herein relate to a battery cell, wherein a dimension of an end of the first tab is substantially twice a dimension of an end of the second tab.

In some aspects, the techniques described herein relate to a battery cell, wherein the first tab is spaced-apart from the third edge by a distance substantially 50% greater than the distance the second tab is spaced-apart from the fourth edge.

In some aspects, the techniques described herein relate to a battery cell, wherein: the housing includes a centerline extending perpendicular to the first and second edges, a centerline of the first tab is spaced-apart from the centerline of the housing in the direction of the third edge, and a centerline of the second tab is spaced-apart from the centerline of the housing in the direction of the fourth edge.

In some aspects, the techniques described herein relate to a method, including: arranging first and second tabs relative to a housing of a battery cell such that a first tab protrudes outwardly from a first edge of the housing and a second tab protrudes outwardly from a second edge of the housing, wherein a dimension of the first edge and a dimension of the second edge are greater dimensions than any other edges of the housing.

In some aspects, the techniques described herein relate to a method in claim 18, wherein: the housing includes a centerline extending perpendicular to the first and second edges, a centerline of the first tab is spaced-apart from the centerline of the housing in the direction of the third edge, and a centerline of the second tab is spaced-apart from the centerline of the housing in the direction of the fourth edge.

In some aspects, the techniques described herein relate to a method, wherein the first tab exhibits a different surface area than the second tab.

### BRIEF DESCRIPTION OF THE DRAWINGS

FIG. 1 schematically illustrates an electrified vehicle.

FIG. 2 is a perspective view of a traction battery pack of an electrified vehicle.

FIG. 3 is a highly schematic cross-sectional view of the traction battery pack of FIG. 2.

FIG. 4 is a perspective view of a battery cell for use within a traction battery pack. In FIG. 4, the battery cell exhibits a first tab cell configuration.

FIG. 5 is a top view of the battery cell of FIG. 4.

FIG. 6 illustrates a battery cell with a second tab cell configuration.

FIG. 7 illustrates a battery cell with a third tab cell configuration.

FIG. 8 illustrates a battery cell with a fourth tab cell configuration.

FIG. 9 illustrates a battery cell with a fifth tab cell configuration.

### DETAILED DESCRIPTION

This disclosure relates generally to electrified vehicle traction battery packs, and more particularly to battery cell tab configurations. The battery cell tab configurations of the present disclosure provide a battery cell with minimum temperature and current density gradients, such that there are minimal variations in temperature and current density across the battery cell. In turn, this disclosure provides a battery cell with increased performance, increased efficiency, and consistent charging. These and other features are discussed in greater detail in the following paragraphs of this detailed description.

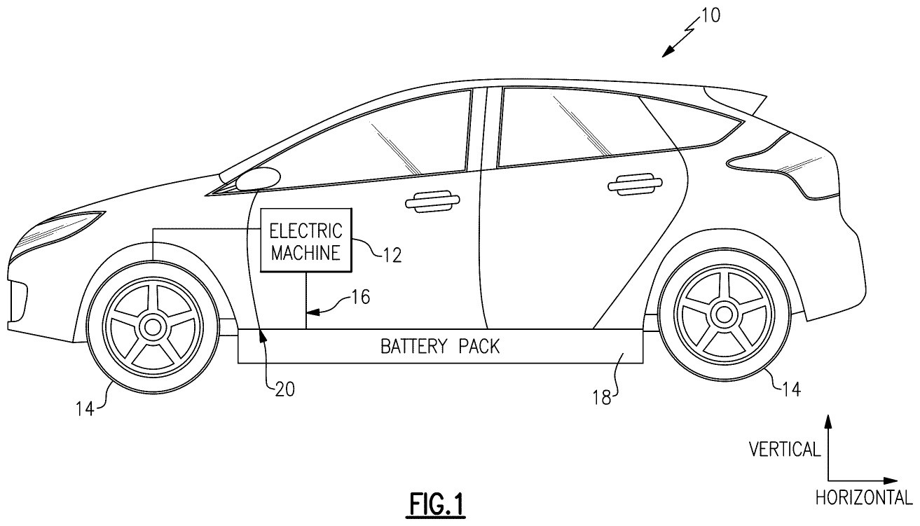

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

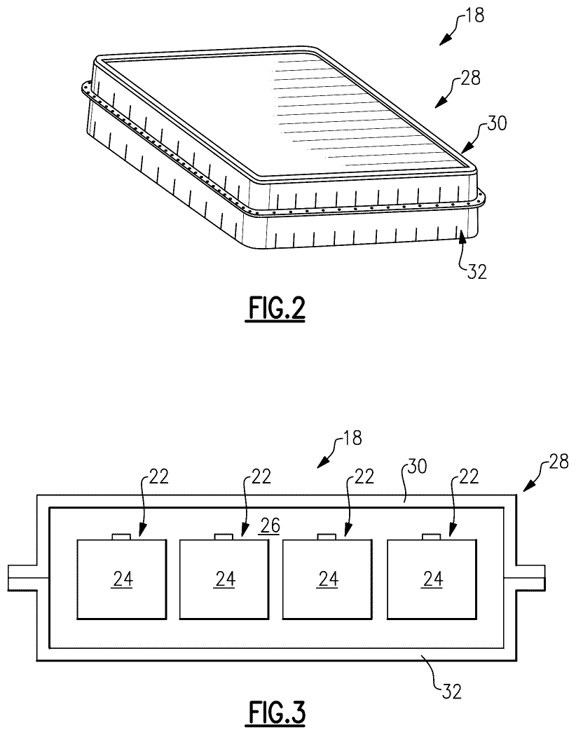

FIGS. 2 and 3 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked side-by-side along a stack axis to construct a grouping of battery cells 24, sometimes referred to as a “cell stack.” In the highly schematic depiction of FIG. 3, the battery cells 24 are stacked in a direction into the page to construct each battery array 22, and thus the battery arrays 22 may extend in cross-car direction. However, other configurations may also be possible. The total numbers of battery arrays 22 and battery cells 24 provided within the traction battery pack 18 are not intended to limit this disclosure. In an embodiment, the battery cells 24 of each battery array 22 are pouch style, lithium-ion cells.

The battery arrays 22 and various other battery internal components (e.g., bussed electrical center, battery electric control module, wiring, connectors, etc.) may be housed within an interior area 26 (see FIG. 3) of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

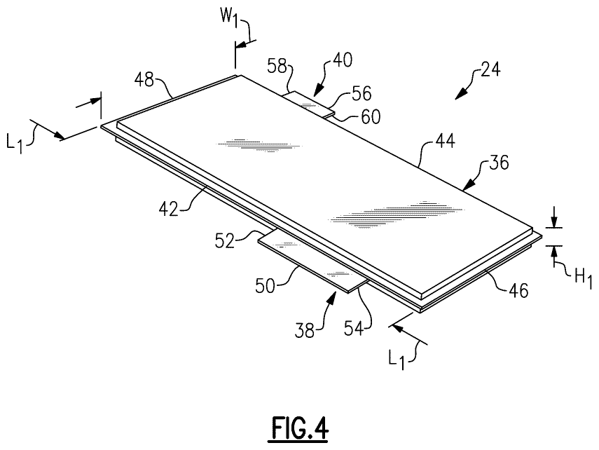

FIG. 4 illustrates one of the battery cells 24 that can be provided within the traction battery pack 18. Each battery cell 24 includes a housing 36 and a pair of tab terminals 38, 40 that protrude outwardly from the housing 36. In an embodiment, each battery cell 24 includes two tab terminals 38, 40, which may be referred to as battery cell tabs or simply tabs. The tabs 38, 40 may be made of different materials. In one example, tab 38 is a positive tab terminal and is made of aluminum, while tab 40 is a negative tab terminal and is made of copper or nickel. The tabs 38, 40 are electrically coupled to electrodes within the housing 36.

The housing 36 is provided by a non-rigid, flexible pouch, in this example. The housing 36 includes a length L₁, a width W₁, and a height H₁. The length L₁ is greater than the width W₁. The width W₁ is greater than the height H₁.

The housing 36 includes a first edge 42, a second edge 44 on an opposite side of the housing 36 as the first edge 42, a third edge 46 extending between the first and second edges 42, 44, and a fourth edge 48 on an opposite side of the housing 36 as the third edge 46 and extending between the first and second edges 42, 44. The first and second edges 42, 44 exhibit a dimension equal to the length L₁, and the third and fourth edges 46, 48 exhibit a dimension equal to the width W₁. The first and second edges 42, 44 exhibit greater dimensions than any other edges of the housing 36. The edges 42, 44, 46, 48 are the outer edges of the housing 36 and provide a perimeter of the housing 36. The housing 36 is substantially rectangular in this embodiment. The edges 42, 44, 46, 48 may be formed by sealing the material of the housing 36.

In this disclosure, the tabs 38, 40 protrude outwardly from the first and second edges 42, 44, and not from the third or fourth edges 46, 48. Arranging the tabs 38, 40 such that they project from the first and second edges 42, 44, which exhibit the greatest dimensions of any edges of the housing 36, provides for greater design flexibility with respect to the size and location of the tabs 38, 40.

With joint reference to FIGS. 3 and 4, the tab 38 includes a free end 50 and first and second sides 52, 54 leading to the free end 50. The tab 40 likewise includes a free end 56 and first and second sides 58, 60 leading to the free end 56.

An aspect of this disclosure relates to offsetting the tabs 38, 40. In an embodiment, the tab 38 is closer to the third edge 46 than the fourth edge 48, and the second tab 40 is closer to the fourth edge 48 than the third edge 46. In particular, the housing 36 includes a centerline C₁ bisecting the first and second edges 42, 44. Centerline C₁ extends perpendicular to the first and second edges 42, 44. A centerline C₂ of tab 38 is spaced-apart from the centerline C₁ in the direction of the third edge 46. Further, a centerline C₃ of the tab 40 is spaced-apart from the centerline C₁ in the direction of the fourth edge 48. The centerlines C₂, C₃ bisect a respective tab 38, 40 and extend parallel to centerline C₁.

In a particular aspect of this disclosure, the centerlines C₂, C₃ of the respective tabs 38, 40 are spaced-apart from the centerline C₁ by different distances. In one particular embodiment, the centerline C₂ of tab 38 is spaced-apart from the centerline C₁ by distance D₁, and the centerline C₃ of tab 40 is spaced-apart from the centerline C₁ by distance D₂. In an example, distance D₂ is greater than distance D₁. In a more particular example, distance D₂ is substantially 50% greater than distance D₁.

In another aspect of this disclosure, the tabs 38, 40 are spaced-apart from the third and fourth edges, respectively, by different amounts. For instance, tab 38, and in particular side 54, is spaced-apart from the third edge 46 by distance D₃, while tab 40, and in particular side 58 is spaced-apart from fourth edge 48 by distance D₄. In an example, distance D₃ is greater than distance D₄. In a more particular example, distance D₃ is substantially 50% greater than distance D₄.

Another aspect of this disclosure relates to the tabs 38, 40 being differently-sized. In particular, the tabs 38, 40 exhibit different surface areas. Specifically, in the embodiment of FIGS. 4 and 5, the tab 38 exhibits a greater surface area than the tab 40. The surface area of tab 38 is defined by free end 50, which exhibits length L₂, and sides 52, 54, which exhibit width W₂. The surface area of tab 40 is defined by free end 56, which exhibits length L₃, and sides 58, 60, which exhibit width W₃. Widths W₂, W₃ are equal in this example. Length L₂ is substantially twice length L₃ in this example. As such, the surface area of tab 38 is substantially twice the surface area of tab 40.

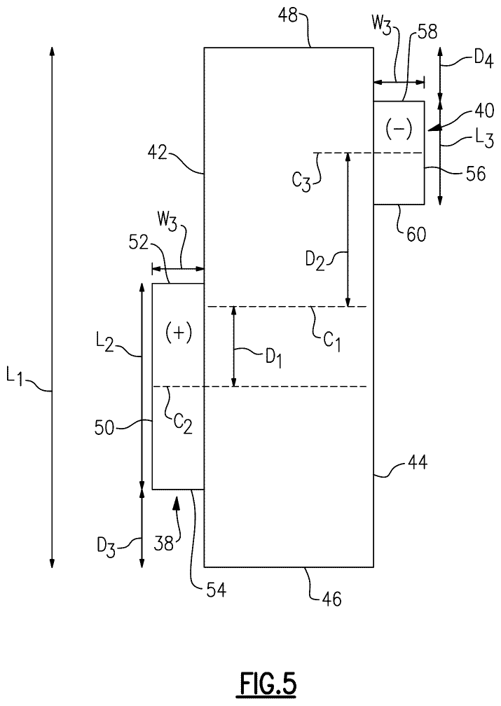

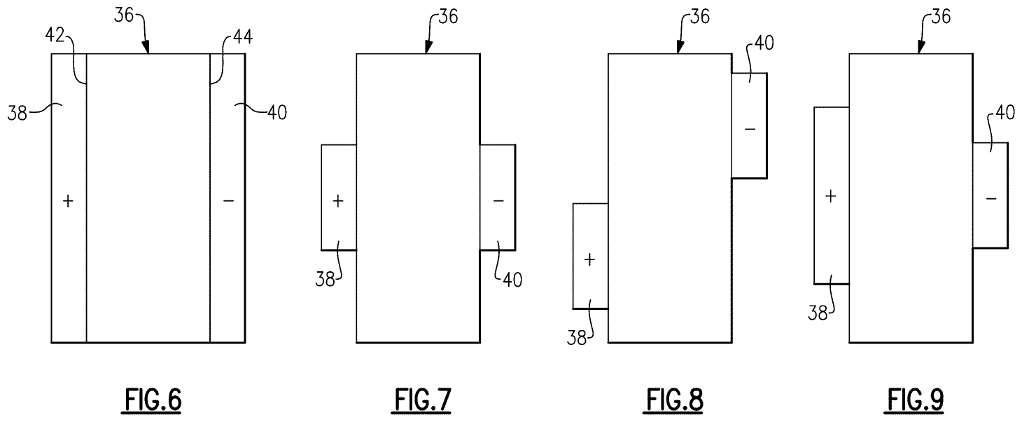

In the embodiment of FIGS. 4 and 5, the tabs 38, 40 (i) protrude from the longest edges of the housing 36, (ii) are arranged asymmetrically along the edges 42, 44 (i.e., their respective centerlines C₂, C₃ are spaced-apart from the centerline C₁ in opposite directions), and (iii) are asymmetrically sized (i.e., they exhibit different surface areas). While the embodiment of FIGS. 4 and 5 may have particular benefits, this disclosure extends to other tab configurations in which the tabs 38, 40 protrude from the longest edges of the housing 36. For example, in FIG. 6, the tabs 38, 40 exhibit a length equal to the length L₁ of the first and second edges 42, 44. In FIG. 6, the tabs 38, 40 are arranged symmetrically along first and second edges 42, 44 and are symmetrically sized. In FIG. 7, the tabs 38, 40 are arranged symmetrically along first and second edges 42, 44 and are symmetrically sized, but exhibit a length less than the length L₁ of the first and second edges 42, 44. In FIG. 8, the tabs 38, 40 are arranged asymmetrically along first and second edges 42, 44 but are symmetrically sized. In FIG. 9, the tabs 38, 40 are arranged symmetrically along first and second edges 42, 44 but are asymmetrically sized.

It should be understood that terms such as “about,” “substantially,” and “generally” are not intended to be boundaryless terms, and should be interpreted consistent with the way one skilled in the art would interpret those terms. It should also be understood that directional terms such as “upper,” “top,” “vertical,” “forward,” “rear,” “side,” “above,” “below,” etc., are used herein relative to the normal operational attitude of a vehicle for purposes of explanation only, and should not be deemed limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery cell, comprising:
a housing including a first edge, a second edge on an opposite side of the housing as the first edge, a third edge extending between the first and second edges, and a fourth edge on an opposite side of the housing as the third edge and extending between the first and second edges, wherein a dimension of the first edge and a dimension of the second edge are greater dimensions than any other edges of the housing;
a first tab that protrudes outwardly from the first edge; and
a second tab that protrudes outwardly from the second edge.

2. The battery cell as recited in claim 1, wherein:
the housing includes a centerline extending perpendicular to the first and second edges,
a centerline of the first tab is spaced-apart from the centerline of the housing in the direction of the third edge, and
a centerline of the second tab is spaced-apart from the centerline of the housing in the direction of the fourth edge.

3. The battery cell as recited in claim 2, wherein the centerline of the first tab is spaced-apart from the centerline of the housing by a different distance than the centerline of the second tab.

4. The battery cell as recited in claim 3, wherein:
the first tab exhibits a greater surface area than the second tab, and
the centerline of the first tab is spaced-apart from the centerline of the housing by a lesser distance than the centerline of the second tab.

5. The battery cell as recited in claim 4, wherein the first tab is spaced-apart from the third edge by a greater distance than the second tab is spaced-apart from the fourth edge.

6. The battery cell as recited in claim 5, wherein the first tab is spaced-apart from the third edge by a distance substantially 50% greater than the distance the second tab is spaced-apart from the fourth edge.

7. The battery cell as recited in claim 4, wherein the centerline of the second tab is spaced-apart from the centerline of the housing by a distance substantially 50% greater than the distance by which the centerline of the first tab is spaced-apart from the centerline of the housing.

8. The battery cell as recited in claim 7, wherein the surface area of the first tab is substantially twice the surface area of the second tab.

9. The battery cell as recited in claim 8, wherein a dimension of an end of the first tab is substantially twice a dimension of an end of the second tab.

10. The battery cell as recited in claim 9, wherein the first tab and the second tab protrude outwardly beyond respective first and second edges, respectively, by the same distance.

11. The battery cell as recited in claim in claim 1, wherein the housing is a flexible pouch.

12. The battery cell as recited in claim 1, wherein the battery cell is part of a battery pack of an electrified vehicle.

13. A battery cell, comprising:
a housing including a first edge, a second edge on an opposite side of the housing as the first edge, a third edge extending between the first and second edges, and a fourth edge on an opposite side of the housing as the third edge and extending between the first and second edges, wherein a dimension of the first edge and a dimension of the second edge are greater dimensions than any other edges of the housing;
a first tab that protrudes outwardly from the first edge;
a second tab that protrudes outwardly from the second edge;
wherein the first tab exhibits a greater surface area than the second tab, and
wherein the first tab is closer to the third edge than the fourth edge and the second tab is closer to the fourth edge than the third edge.

14. The battery cell as recited in claim 13, wherein the surface area of the first tab is substantially twice the surface area of the second tab.

15. The battery cell as recited in claim 14, wherein a dimension of an end of the first tab is substantially twice a dimension of an end of the second tab.

16. The battery cell as recited in claim 13, wherein the first tab is spaced-apart from the third edge by a distance substantially 50% greater than the distance the second tab is spaced-apart from the fourth edge.

17. The battery cell as recited in claim 13, wherein:
the housing includes a centerline extending perpendicular to the first and second edges,
a centerline of the first tab is spaced-apart from the centerline of the housing in the direction of the third edge, and
a centerline of the second tab is spaced-apart from the centerline of the housing in the direction of the fourth edge.

18. A method, comprising:
arranging first and second tabs relative to a housing of a battery cell such that a first tab protrudes outwardly from a first edge of the housing and a second tab protrudes outwardly from a second edge of the housing, wherein a dimension of the first edge and a dimension of the second edge are greater dimensions than any other edges of the housing.

19. The method as recited in claim in claim 18, wherein:
the housing includes a centerline extending perpendicular to the first and second edges,
a centerline of the first tab is spaced-apart from the centerline of the housing in the direction of the third edge, and
a centerline of the second tab is spaced-apart from the centerline of the housing in the direction of the fourth edge.

20. The method as recited in claim 18, wherein the first tab exhibits a different surface area than the second tab.
